(19) United States
(12) Patent Application Publication
(10) Pub. No.: US 2017/0015028 A1
(43) Pub. Date: Jan. 19, 2017

(54) PROTECTIVE TUBE FOR COIL SPRING AND METHOD FOR MANUFACTURING THE SAME

(71) Applicant: Dong Yang Physical & Chemical CO., Ltd., Anseong-si (KR)

(72) Inventor: Won Sik LEE, Seoul (KR)

(21) Appl. No.: 15/196,989

(22) Filed: Jun. 29, 2016

(30) Foreign Application Priority Data
Jul. 13, 2015 (KR) 10-2015-0099072

(51) Int. Cl. B29C 45/00; C08L 75/04; C08J 3/28; C08J 3/24; C08J 3/00; C08J 3/20

(52) U.S. Cl. CPC B29C 45/0001; C08J 3/005; C08J 3/20; C08J 3/28; C08J 3/24; C08L 75/04; C08L 2201/08; C08L 2207/062; C08L 2207/066; C08J 2375/04; C08J 2427/06; C08J 2423/06; C08J 2423/08; C08J 2431/04; B29K 2101/12

(57) ABSTRACT

A protective tube for a coil spring and a method for manufacturing the same are disclosed herein. The protective tube for a coil spring is manufactured by: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube; crosslinking the tube by radiation; enlarging the diameter of the crosslinked tube while forming the tube into a spiral shape by heating; and setting the enlarged-diameter tube by cooling.

### BACKGROUND

1. Technical Field

The present invention relates generally to a protective tube for a vehicle suspension coil spring and a method for manufacturing the same, and more particularly to a protective tube for a vehicle suspension coil spring, which includes a heat-shrinkable tube made of a highly durable thermoplastic elastomer and thermoplastic resin and thus has excellent durability, which can effectively prevent the infiltration of foreign materials and water, and which can be easily mounted in a vehicle, thereby effectively protecting a coil spring and also enhancing safety, and to a method for manufacturing the same.

2. Description of the Related Art

In general, a suspension system installed in a vehicle absorbs shocks applied to wheels during driving, thereby protecting the driver, passengers and various internal devices of the vehicle from shocks while offering comfort to the driver and the passengers.

FIG. 1 is a schematic view of a general vehicle suspension system. The suspension system is commonly installed between a frame and an axle below the frame in order to maintain the axle, on which tires are installed, in an elastic state. A coil spring is a part of the vehicle suspension system, and is equipped with a protective tube fitted and assembled thereover so as to enable the coil spring to withstand severe usage conditions.

A conventional protective tube for a coil spring is formed in the shape of a cut tube, and is used in the state in which it is fitted over a coil spring and a gap is bonded. However, foreign materials (e.g., soil, sand or gravel) or water on a road infiltrate into the protective tube through the gap with the passage of time. Such foreign materials that have infiltrated into the protective tube may be spread between the protective tube and the coil spring during the repeated expansion and compression of the coil spring, thereby either causing corrosion by damaging the coating of the coil spring or damaging the protective tube.

In an attempt to overcome this problem, a heat-shrinkable protective tube made of a polyolefin-based material was proposed, which was formed to have an inner diameter adapted to enable the easy fitting of the protective tube and was then fitted over a coil spring by heat shrinkage. However, this protective tube for a coil spring, which is made of the conventional material, has problems in that it has insufficient physical properties, such as durability, and in that it may be separated from the coil spring or twisted, even though it is easily fitted over the coil spring. In addition, the infiltration of foreign materials or water into the protective tube still remains problematic.

### SUMMARY

At least one embodiment of the present invention is directed to the provision of a protective tube for a vehicle suspension coil spring, which is formed of a heat-shrinkable material having high mechanical strength, abrasion resistance, chemical resistance and elasticity and low thermal conductivity, and thus achieves enhanced durability and safety while improving a manufacturing process.

At least one embodiment of the present invention is directed to the provision of a method for manufacturing a protective tube for a vehicle suspension coil spring, which can prevent a protective tube made of a heat-shrinkable tube from being separated from a coil spring or from being twisted while facilitating the operation of assembling the protective tube over the coil spring.

In accordance with an aspect of the present invention, there is provided a protective tube for a coil spring, which is manufactured by: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube; crosslinking the tube by radiation; enlarging the diameter of the crosslinked tube while forming the tube into a spiral shape by heating; and setting the enlarged-diameter tube by cooling.

In accordance with another aspect of the present invention, there is provided a method for manufacturing a protective tube for a coil spring, including: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube while applying a hot-melt adhesive to the inside of the tube; crosslinking the extrusion-molded tube by radiation; enlarging the diameter of the crosslinked tube while forming the tube into a spiral shape by heating; and setting the enlarged-diameter tube by cooling.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view of a coil spring mounted in a vehicle suspension system;

FIG. 2 is a schematic perspective view showing a protective tube for a coil spring according to an embodiment of the present invention in the state in which the protective tube is fitted over a coil spring; and

FIG. 3 is a schematic perspective view showing a protective tube for a coil spring according to an embodiment of the present invention before and after the heat shrinkage of the protective tube fitted over a coil spring.

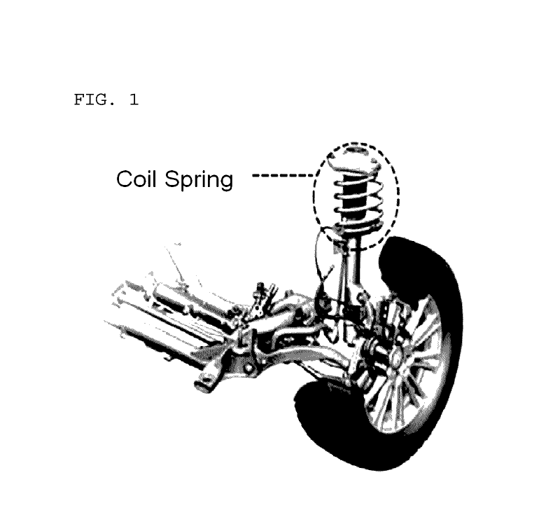

### DETAILED DESCRIPTION

Embodiments of the present invention will be described in detail below with reference to the accompanying drawings. In the following description, detailed descriptions of related known functions or configurations will be omitted when they may make the gist of the present invention obscure.

A protective tube for a coil spring according to an embodiment of the present invention is manufactured by: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube; crosslinking the tube by radiation; enlarging the diameter of the crosslinked tube while forming the tube into a spiral shape by heating; and setting the enlarged-diameter tube by cooling.

Heat-shrinkable tubes for electric wires, which are made of polyethylene, polyethylene vinyl acetate (EVA) or rubber, are not required to have high physical properties, durability or hydrolysis resistance, whereas heat-shrinkable tubes for vehicle coil springs are required to have physical properties and durability, which are comparable to those of conventional thermoplastic polyurethane (TPU). However, since thermoplastic polyurethane materials cannot exhibit heat shrinkage properties, conventional protective tube products are manufactured to have an inner diameter that is about 0.2-0.5 mm greater than the outer diameter of a coil spring, and are then forcibly fitted over the coil spring. When the difference between the outer diameter of the coil spring and the inner diameter of the protective tube is large, a problem may arise in that foreign materials easily infiltrate into the protective tube and break the coil spring. In contrast, when the difference between the outer diameter of the coil spring and the inner diameter of the protective tube is small, a problem may arise in that it is difficult to fit the protective tube over the coil spring. For these reasons, according to the present embodiment, a heat-shrinkable property is imparted to a thermoplastic elastomer material, thereby providing a protective tube for a coil spring having excellent physical properties, such as durability, while overcoming the problem related to the breakage of a coil spring caused by the infiltration of foreign materials.

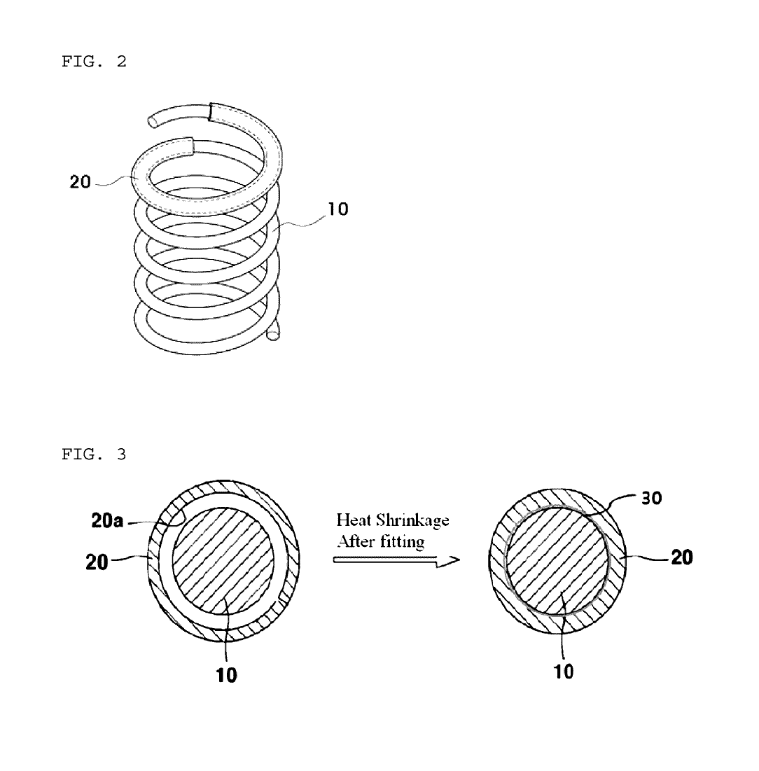

FIG. 2 is a schematic perspective view showing a protective tube for a coil spring according to an embodiment of the present invention, and FIG. 3 is a schematic perspective view showing a change in the cross-sectional structure of a protective tube for a coil spring according to an embodiment of the present invention before and after the heat shrinkage of the protective tube fitted over a coil spring. As shown in FIG. 3, a protective tube 20 for a coil spring according to an embodiment of the present invention is manufactured to have an inner diameter greater than the outer diameter of a coil spring 10, and is configured such that it is shrunk by heat and thus adheres closely to the coil spring 10 after fitting over the coil spring 10. In addition, the protective tube 20 for a coil spring is a spiral- or coil-shaped, heat-shrinkable tube having a pitch (P) corresponding to that of the coil spring 10 over which it is to be fitted.

The protective tube 20 for a coil spring according to the present embodiment is an enhanced-durability, heat-shrinkable tube that is manufactured using a blend of a thermoplastic resin with a thermoplastic elastomer which has not been used as a material for heat-shrinkable tubes but which has high physical properties.

The thermoplastic elastomer that is used in the present embodiment may be one or more selected from the group consisting of a polyolefin-based thermoplastic elastomer (TPO), a polystyrene-based thermoplastic elastomer (TPS), a polyimide-based thermoplastic elastomer (TPA), a polyurethane-based thermoplastic elastomer (TPU), a polyester-based thermoplastic elastomer (TPC), and a thermoplastic vulcanizate (TPV).

In a preferred embodiment of the present invention, the thermoplastic elastomer is thermoplastic polyurethane (TPU). Thermoplastic polyurethane resin has excellent flexibility, heat resistance and abrasion resistance, and also has excellent heat resistance, abrasion resistance, oil resistance, solvent resistance, impact resistance, cold resistance, durability and the like, which are superior to those of polyvinyl chloride (PVC), polyester or the like. In addition, since it exhibits high elongation and strength and the physical properties thereof are less dependent on additives such as a plasticizer, it is an ideal environmentally friendly material.

The thermoplastic polyurethane resin that is used in the present embodiment may be prepared by reacting an organic polyisocyanate compound, which is used in the preparation of conventional thermoplastic polyurethane resin, with a compound having active hydrogen, if necessary, in the presence of an additive. The compound having active hydrogen is preferably polyol or a polyol-based compound. These compounds may be used individually or in combination.

The thermoplastic vulcanizate (TPV) is a compound having a continuous thermoplastic phase and a vulcanized elastomer phase dispersed in the continuous thermoplastic phase. The TPV has the preferred properties of crosslinked rubber together with some properties of a thermoplastic elastomer. The TPV is prepared by a process known as dynamic vulcanization or dynamic crosslinking, and this process includes mixing a thermoplastic component with a vulcanizable elastomer component under shear at a temperature equal to or higher than the melting point of the thermoplastic component in the presence of a plasticizer that acts to vulcanize the elastomer component.

The protective tube for a coil spring according to the present embodiment includes 40-70 parts by weight of a thermoplastic elastomer. If the content of the thermoplastic elastomer in the protective tube for a coil spring is less than 40 parts by weight, the effect of enhancing the durability of the protective tube will be insufficient; and if the content of the thermoplastic elastomer is more than 70 parts by weight, the heat shrinkability of the protective tube will be reduced.

The thermoplastic resin that is used in the present embodiment may include at least one selected from the group consisting of polyvinyl chloride (PVC)-based resin, polyamide-based resin, polyethylene-based resin, polyester-based resin, polycarbonate-based resin, polystyrene-based resin, ethylene vinyl acetate (EVA) resin, and polyacetal resin. In a preferred embodiment of the present invention, the thermoplastic resin is polyvinyl chloride or maleic anhydride graft ethylene vinyl acetate (MAH-g-EVA).

The polyethylene is a kind of polyolefin. As used herein, the term “polyolefin” refers to a group of polymer compounds produced by olefin polymerization. Since only olefins (or α-olefins) having a double bond at the end can be freely polymerized, polyethylene, polypropylene, polyisobutylene and the like belong to the class of polyolefins.

Examples of the polyethylene include low-density polyethylene (LDPE), high-density polyethylene (HDPE), and linear low-density polyethylene (LLDPE) which is prepared at low pressure and which has properties similar to those of high-density polyethylene. Preferably, the polyethylene that is used in the present embodiment is low-density polyethylene (LDPE) or high-density polyethylene (HDPE).

The ethylene vinyl acetate (EVA) resin is a resin whose physical properties are determined by the degree of polymerization and the content of vinyl acetate. Specifically, as the molecular weight of the ethylene vinyl acetate resin increases, the toughness, plasticity and impact resistance thereof increase, and the formability or surface gloss thereof decreases. As the vinyl acetate content of the ethylene vinyl acetate resin increases, the density and rubber elasticity thereof and the compatibility thereof with a polymer having a different flexibility or with a plasticizer increase, and thus the softening temperature thereof decreases. Generally, an ethylene vinyl acetate resin having a vinyl acetate (VA) content of about 10-40% is used to improve formability or low-temperature flexibility by blending with PVC or other resins, and an ethylene vinyl acetate resin having a vinyl acetate (VA) content of 25-30% is effective in improving the brittleness and adhesive properties of waxes. The EVA resin that is used in the present embodiment preferably has a vinyl acetate content of 15-25%.

The antioxidant is a material that is added to prevent autoxidation from being caused by the action of oxygen. As the antioxidant, hindered phenol-based antioxidants or thiol-based antioxidants may be used individually or in combination.

The crosslinking agent is a monomer that is used to form crosslinks between the thermoplastic resin and the thermoplastic elastomer by grafting onto these resins. Examples of the crosslinking agent that is used in the present embodiment include nontoxic crosslinking agents, including TMPTMA (trimethylolpropane trimethacrylate), EGDMA (ethyleneglycol dimethacrylate), DEGDMA (diethyleneglycol dimethacrylate), TTEGDMA (tetraethyleneglycol dimethacrylate), PEGDMA (polyethyleneglycol dimethacrylate), and PPGDMA (polypropyleneglycol dimethacrylate). Among these crosslinking agents, TMPTMA (trimethylopropane trimethacrylate) is most preferably used.

The protective tube for a coil spring according to the present embodiment may further include any one or more additives selected from the group consisting of a plasticizer, a filler, a thermal stabilizer, a flame retardant, a flame retardant aid, a processing aid, and an internal lubricant. The flame retardant aid is at least one selected from among silicon compounds and boron compounds, and the antioxidant may include at least one selected from among hindered phenol-based antioxidants or thiol-based antioxidants.

The plasticizer is a phthalate-based plasticizer that is most frequently used due to its excellent compatibility with thermoplastic resins. Examples of phthalate-based plasticizer include DBP (dibutyl phthalate), DOP (dioctyl phthalate), DINP (diisononyl phthalate), DIDP (diisodecyl phthalate), BBP (butyl benzyl phthalate), etc., and examples of a trimellitate-based plasticizer that may be used in the present embodiment include TOTM (trioctyl trimellitate), TINTM (triisononyl trimellitate), TIDTM (triisodecyl trimellitate), etc. Among these plasticizers, TOTM (trioctyl trimellitate) is most preferably used in terms of environmental protection and compatibility.

The filler is a material that is added for the purposes of anti-aging, reinforcement and bulking in the practical use of rubber or plastic materials. It is added in an amount of about 5-15 parts by weight based on the total weight of the protective tube. If the content of the filler in the protective tube is less than 5 parts by weight, the strength of the protective tube will be reduced; and if the content of the filler is more than 15 parts by weight, the strength of the protective tube will excessively increase so that the thermal shrinkage and expansion of the protective tube will not easily occur.

The thermal stabilizer, also known as a resin stabilizer, is a chemical agent that is added to plastics or the like in order to prevent or suppress deterioration. If the content of the thermal stabilizer in the protective tube is less than 0.2 parts by weight, it will not prevent deterioration; and if the content of the thermal stabilizer is more than 3 parts by weight, it will not be easily mixed with other components. Thermal stabilizers that are used in the art include lead-based stabilizers, stabilizers based on metals such as Ba—Cd, Ca—Zn, Ba—Zn or the like, organotin stabilizers, etc. The lead-based stabilizers are excellent in terms of electrical insulation properties, weather resistance, long-term thermal stability, etc., but the use thereof is limited due to their toxicity. The Ba—Cd stabilizers have excellent thermal stability and transparence, but the use thereof is limited due to problems associated with the heavy metal cadmium. The Ca—Zn stabilizers are nontoxic stabilizers that are most preferably used in view of environmental protection. Examples of Ca—Zn stabilizers that may be used in the present embodiment include zinc stearate, calcium stearate, and a mixture thereof.

The compatibilizer is used to improve the compatibility of a resin mixture that is a blend of two or more polymers, and examples thereof include silane-based compatibilizers such as monoamine silane-, diamine silane- or monoisocyanate silane-based compatibilizers. In addition, the compatibilizer that may be used in the present embodiment may be either a compatibilizer having good compatibility with maleic anhydride graft ethylene vinyl acetate (MAH-g-EVA) which is prepared by grafting maleic anhydride, which is a polar group having strong electronegativity and which also has the property of forming a hydrogen bond with an OH group by a ring-opening condensation reaction, or a compatibilizer having good compatibility with a PVC/NBR (nitrile butadiene rubber) mixture which is a partially crosslinked elastomer having a polar group.

The protective tube for a coil spring according to the present embodiment may further include a flame retardant to impart flame retardant properties. Examples of a flame retardant that may be used in the present embodiment include inorganic metal hydroxide flame retardants, phosphorus-based flame retardants, melamine-based flame retardants, borate-based flame retardants, and silicon-based flame retardants. The phosphorus-based flame retardant that may be used in the present embodiment may be one or more selected from among triphenyl phosphate, triaryl phosphate, aromatic phosphoric acid ester, 2-ethylhexyldiphenyl phosphate, nitrogen-phosphorus, crazylphenyl phosphate, cresyl diphenyl phosphate, chloroethyl phosphate, tris-β-chloropropyl phosphate, tris-dichloropropyl phosphate, aromatic condensed phosphoric acid ester, polyphosphate, and red phosphorus. If the flame retardant is added in excessively small amounts, the flame retardant property of the protective tube will be reduced; and if the flame retardant is added in excessively large amounts, the physical properties of the protective tube will be reduced. For these reasons, it is required to add a suitable amount of the flame retardant in order to optimize the flame retardancy and physical properties of the protective tube.

A flame retardant aid capable of reducing the generation of smoke while improving the flame retardant property of the flame retardant may be used in the present embodiment. As the flame retardant aid, a silicon compound and a boron compound may be used individually or in combination.

The protective tube for a coil spring according to the present embodiment has advantages in that it can be easily fitted over the coil spring because it is manufactured to have an inner diameter greater than the outer diameter of the coil spring during tube enlargement/formation and in that it is easily fitted because it has a coil shape that is the same as that of the coil spring. In addition, since the protective tube adheres closely to the coil spring by heat shrinkage, there is no space between the coil spring and the protective tube, and thus the peeling of the surface coating of the coil spring by impurities can be prevented, thereby extending the life span of the coil spring.

In addition, the protective tube for a coil spring according to the present embodiment may be manufactured such that a hot-melt adhesive is applied to the inner surface of the tube during the compression molding of the tube. When the hot-melt adhesive is applied to the inner surface of the protective tube, the protective tube can be prevented from separation or twisting to thereby further improve the service life of the tube, and the adhesion between the coil spring and the protective tube will be increased such that the infiltration of foreign materials and water into the protective tube can be reliably prevented. Non-limiting examples of this hot-melt adhesive may include one or more selected from among ethylene vinyl acetate, polyamide, and polystyrene.

Another aspect of the present invention is directed to a method for manufacturing a protective tube for a vehicle suspension coil spring, including: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube while applying a hot-melt adhesive to the inside of the tube; crosslinking the extrusion-molded tube by radiation; enlarging the diameter of the crosslinked tube while forming the tube into a spiral shape by heating; and setting the enlarged-diameter tube by cooling.

The protective tube for a coil spring manufactured according to the present embodiment is cut to a suitable length, inserted around a coil spring, and then shrunk by heat to adhere closely to the protective tube. In the following, each step of the manufacturing method of the present invention will be described in further detail.

In the method of the present invention, 40-70 parts by weight of a thermoplastic elastomer, 20-40 parts by weight of a thermoplastic resin, 0.2-5 parts by weight of an antioxidant, and 0.2-5 parts by weight of a crosslinking agent are first melted and mixed, and the mixture is cooled and formed into pellets having a certain shape. This step may be performed using a conventional pellet preparation method known in the art or a single-screw extruder, a twin-screw extruder, a mixing roll, a Banbury mixer, a kneader or the like, and the size and shape of the pellets are also not limited.

Thereafter, the pellets obtained in the previous step are extruded by an extrusion molding machine and cooled, thereby continuously forming a tube having a space therein. At this time, a hot-melt adhesive is applied on the inner surface of the tube being extruded. This hot-melt adhesive can exhibit an adhesive property to maximize the adhesion between a coil spring and the protective tube when the expanded heat-shrinkable tube is adhered closely to the coil spring by heat after fitting over the coil spring. In the crosslinking step, accelerated electron beams, gamma-rays, X-rays, α-rays, UV rays or the like may be used as radiation.

Forming the protective tube 20 into a spiral shape so as to have a curvature corresponding to the pitch (P) of the coil spring 10 may be achieved as follows. In the process of manufacturing the protective tube, the protective tube is irradiated with radiation to impart a shape memory property to the protective tube, and then heated, pressurized and cooled while it is formed into a spiral shape or a coil shape, thereby manufacturing a spiral- or coil-shaped protective tube 20 having a curvature corresponding to the pitch (P) of the coil spring 10 onto which the protective tube is to be assembled. The irradiated, spiral- or coil-shaped protective tube is heated to a temperature equal to higher than the glass transition point or melting point of the thermoplastic resin that is a base resin, and in this state, the protective tube is expanded to a desired outer diameter, for example, by introducing compressed air therein, and then cooled to set the shape, thereby manufacturing a spiral- or coil-shaped protective tube 20.

To expand and form the protective tube into a spiral or coil shape having a pitch corresponding to the pitch of the coil spring, the tube is wound around a processing frame having a spiral- or coil-shaped guide groove, and then compressed hot air is injected to thermally expand the protective tube, and then set by cooling, thereby forming a protective tube having an inner diameter greater than the outer diameter of the coil spring. If steam is used in this step, a problem may arise in that steam reacts with the hot-melt adhesive in the heat-shrinkable tube to reduce the adhesive strength of the adhesive and change the adhesive portion to white (whitening phenomenon), making the appearance poor. However, this problem can overcome by the use of compressed hot air.

In this case, the inner diameter of the protective tube may be made 0.5-10 mm greater than the outer diameter of the coil spring. In this case, the coil spring can be easily inserted into the protective tube, and the ability of the protective tube to be fitted over the coil spring can be improved, thereby improving operational efficiency and productivity.

After the protective tube 20 has been assembled onto the coil spring 10 by the above-described process, the protective tube 20 is heated using a separate heating unit. Meanwhile, various heating units have been used in the art to heat heat-shrinkable tubes, and the protective tube of the present invention can also be heated using such conventional heating units. Accordingly, a detailed description of the heating unit is omitted.

Meanwhile, the protective tube 20 is shrunk by heat applied to the protective tube 20 from the heating unit as described above. At this time, the protective tube 20 is adhered closely to the coil spring 10, and the inner surface 20a of the protective tube 20 having the hot-melt adhesive applied thereto is adhered closely to the outer surface of the coil spring 10, whereby the protective tube 20 is fitted over the coil spring 10. As shown in FIG. 3, the protective tube 20 manufactured according to the present embodiment has an inner diameter greater than the outer diameter of the coil spring as described above, and thus can be easily assembled onto the coil spring 10. In addition, since a hot-melt adhesive layer 30 is formed between the coil spring 10 and the protective tube 20 when the expanded heat-shrinkable tube is adhered closely to the coil spring after fitting over the coil spring, the separation or twisting of the protective tube can be prevented.

According to the method of the present invention, the protective tube is adhered and bonded firmly to the coil spring, and thus the twisting or separation of the protective tube does not occur and the infiltration of foreign materials or water into the protective tube can be blocked. Accordingly, the durability of the coil spring can be enhanced so that the coil spring can be safely protected. Therefore, a significant car crash caused by the breakage of the coil spring mounted in the car can be prevented.

The present invention will be described in greater detail below with reference to examples. It is to be understood, however, that these examples are for illustrative purposes only and are not intended to limit the scope of the present invention.

### EXAMPLES

### Examples 1 to 4 and Comparative Examples 1 to 3

Using the components and contents shown in Table 1 below, pellets for manufacturing protective tubes for coil springs were prepared. In Table 1, the content of each component is expressed in parts by weight unless otherwise specified.

TABLE 1

| | | | | | | Comparative | | |
|---|---|---|---|---|---|---|---|---|
| | | Example | | | | Example | | |
| Components | | 1 | 2 | 3 | 4 | 1 | 2 | 3 |
| Main | TPU | 50 | 50 | 50 | 50 | | | |
| components | PVC | 25 | | | | 100 | | |
| | LDPE | | 25 | | | | 50 | |
| | HDPE | | | 25 | | | 50 | |
| | EVA | | | | 25 | | | 100 |

| | | | | | | | |
|---|---|---|---|---|---|---|---|
| Crosslinking agent | 2 | 2 | 2 | 2 | 2 | 2 | 2 |
| Antioxidant | 0.5 | 0.5 | 0.5 | 0.5 | 0.5 | 0.5 | 0.5 |

PVC: PVC having a polymerization degree of 1300
TPU: TPU 85A
Crosslinking agent: TMPTMA (trimethylolpropane trimethacrylate)
Antioxidant: 3,5-bis(1,1-dimethylethyl)-4-hydroxybenzenepropanoic acid octadecyl ester

In Examples 1 to 3 and Comparative Examples 1 to 3, linear heat-shrinkable tubes (inner diameter: 12 mm; thickness: 2 mm) were manufactured by extrusion, and then expanded tubes having a spiral shape were manufactured from the heat-shrinkable tubes using a tub expanding machine. The physical properties of the protective tube for a coil springs manufactured in Examples 1 to 4 and Comparative Examples 1 to 3 were measured, and the results of the measurement are shown in Table 2 below:

TABLE 2

| | Example | | | | Comparative Example | | |
|---|---|---|---|---|---|---|---|
| | 1 | 2 | 3 | 4 | 1 | 2 | 3 |
| Tensile | 378 | 370 | 387 | 385 | 157 | 210 | 173 |
| strength | | | | | | | |
| (kgf/cm²) | | | | | | | |
| Elongation | 531 | 415 | 463 | 574 | 394 | 532 | 594 |
| (%) | | | | | | | |
| Tearing | 90 | 82 | 84 | 88 | 61 | 72 | 66 |
| strength | | | | | | | |
| (kgf/cm) | | | | | | | |
| Hardness | 95A | 88A | 97A | 90A | 78A | 80A | 75A |
| (Shore) | | | | | | | |
| Degree of | 12 | 34 | 25 | 31 | 186 | 75 | 61 |
| abrasion | | | | | | | |
| (mg) | | | | | | | |

[Methods for measuring physical properties]
Tensile strength: measured in accordance with KSM M 3824 and given in units of kgf/cm².
Elongation: measured in accordance with KS M 3824 and given in units of %.
Tearing strength: measured in accordance with KS M 3824 and given in units of kgf/cm.
Hardness: measured in accordance with KS M ISO 868 and given in units of kg/cm.
Degree of abrasion: measured in accordance with KS M 3824 and given in units of mg.

The inner and outer diameters (mm) and thicknesses (mm) of the protective tubes for coil springs manufactured using the pellets having the compositions shown in Table 1 were measured in each manufacturing step, and the results of the measurement are shown in Table 3 below:

TABLE 3

| | | Example | | | | Comparative Example | | |
|---|---|---|---|---|---|---|---|---|
| | | 1 | 2 | 3 | 4 | 1 | 2 | 3 |
| As | Inner | 12 | 12 | 12 | 12 | 12 | 12 | 12 |
| manufactured | diameter | | | | | | | |
| | Outer | 16 | 16 | 16 | 16 | 16 | 16 | 16 |
| | diameter | | | | | | | |
| | Thickness | 2 | 2 | 2 | 2 | 2 | 2 | 2 |
| After | Spring | 14.5 | 14.5 | 14.5 | 14.5 | 14.5 | 14.5 | 14.5 |
| fitting | thickness | | | | | | | |
| over coil | Thickness | 1.72 | 1.72 | 1.72 | 1.72 | 1.72 | 1.72 | 1.72 |
| spring | | | | | | | | |

| | | | | | | | |
|---|---|---|---|---|---|---|---|
| Durability | Excellent | Excellent | Excellent | Excellent | Poor | Poor | Poor |
| Fitting ability | Excellent | Excellent | Excellent | Excellent | Excellent | Excellent | Excellent |

For the evaluation of durability, 300,000 repeated fatigue tests were performed at a speed of Stroke Lmax-10 to Lmin10 and 1 Hz in the presence of foreign materials such as sand, and then whether the heat-shrinkable tubes were broken and separated was evaluated. The protective tubes of the present invention were not torn and had an excellent surface state. Meanwhile, the fitting ability was evaluated by the time taken for the protective tube to be fitted over a coil spring having the same dimensions without using a separate insertion device.

The protective tubes of Examples 1 to 4 and Comparative Examples 1 to 3 have excellent fitting ability because the protective tubes are inserted around coil springs after these heat-shrinkable tubes have expanded to have an inner diameter greater than the diameter of the coil springs. However, the protective tubes of Comparative Examples 1 to 3 have poor physical properties (such as tensile strength and tearing strength) compared to the protective tubes of the Examples, and thus are cracked or torn in use, indicating that they have insufficient durability.

As described above, it can be seen that the inner diameter of the protective tube according to the present embodiment is made 0.5-10 mm greater than the outer diameter of the coil spring so that the coil spring can be easily inserted into the protective tube, and thus the ability of the protective tube to be fitted over the coil spring can be improved, thereby improving operational efficiency and productivity. In addition, it can be seen that after fitting over the coil spring, the protective tube of the present invention is shrunk to have an inner diameter corresponding to the outer diameter of the coil spring and adheres closely to the coil spring, and is adhered firmly to the coil spring by the hot-melt adhesive.

As described above, according to at least one embodiment of the present embodiment, a protective tube is formed of a heat-shrinkable material having excellent physical properties, and thus has enhanced durability. Furthermore, the inner and outer diameters of the protective tube are made greater than the diameter of a coil spring, and thus the ability of the protective tube to be fitted over the coil spring can be improved, thereby significantly improving operational efficiency and manufacturing efficiency.

In addition, according to at least one embodiment of the present embodiment, the operation of assembling a protective tube over a coil spring can be performed in an easier and faster manner, and the protective tube can be more firmly adhered to the coil spring so that the separation or twisting of the protective tube can be prevented, thereby increasing the service life of the coil spring and the protective tube.

Since the present invention is not limited to the above-described specific embodiments and it is apparent to those having ordinary knowledge in the art to which the present invention pertains that various modifications and alterations can be made without departing from the gist of the present invention set forth in the claims, the true scope of the present invention should be defined based on the claims and equivalents thereto.

What is claimed is:

1. A protective tube for a coil spring, which is manufactured by: mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture; pelletizing the mixture to obtain pellets; extrusion-molding the pellets into a tube; crosslinking the tube by radiation; enlarging a diameter of the crosslinked tube while forming the tube into a spiral shape by heating; and setting the enlarged-diameter tube by cooling.

2. The protective tube of claim 1, wherein the thermoplastic elastomer is one or more selected from the group consisting of a polyolefin-based thermoplastic elastomer (TPO), a polystyrene-based thermoplastic elastomer (TPS), a polyimide-based thermoplastic elastomer (TPA), a polyurethane-based thermoplastic elastomer (TPU), a polyester-based thermoplastic elastomer (TPC), and a thermoplastic vulcanizate (TPV).

3. The protective tube of claim 1, wherein the thermoplastic resin is one or more selected from the group consisting of polyvinyl chloride-based resin, polyamide-based resin, polyethylene-based resin, polyester-based resin, polycarbonate-based resin, polystyrene-based resin, ethylene vinyl acetate resin, and polyacetal resin.

4. The protective tube of claim 1, wherein at least one hot-melt adhesive selected from the group consisting of ethylene vinyl acetate, polyamide, and polystyrene is applied to an inner surface of the protective tube.

5. The protective tube of claim 1, wherein the thermoplastic elastomer is thermoplastic polyurethane, and the thermoplastic resin is polyvinyl chloride or maleic anhydride graft ethylene vinyl acetate (MAH-g-EVA).

6. The protective tube of claim 1, wherein the protective tube further comprises one or more selected from the group consisting of a plasticizer, a filler, a thermal stabilizer, a flame retardant, a flame retardant aid, a processing aid, and an internal lubricant, wherein the flame-retardant aid is at least one selected from silicon compounds and boron compounds, and wherein the antioxidant is at least one selected from among hindered phenol-based antioxidants or thiol-based antioxidants.

7. A method for manufacturing a protective tube for a coil spring, comprising:
mixing 40-70 parts by weight of a thermoplastic elastomer, 20-40 parts by weight of a thermoplastic resin, 0.2-5 parts by weight of an antioxidant, and 0.2-5 parts by weight of a crosslinking agent to obtain a mixture;
pelletizing the mixture to obtain pellets;
extrusion-molding the pellets into a tube while applying a hot-melt adhesive to an inside of the tube;
crosslinking the extrusion-molded tube by radiation;
enlarging a diameter of the crosslinked tube while forming the tube into a spiral shape by heating; and
setting the enlarged-diameter tube by cooling.

8. The method of claim 7, wherein the hot-melt adhesive is at least one selected from the group consisting of ethylene vinyl acetate, polyamide, and polystyrene.

9. The method of claim 7, wherein enlarging the diameter of the crosslinked tube comprises winding the crosslinked tube around a processing frame including a coil-shaped guide groove, and then expanding the tube into a coil-shaped tube by direct or indirect heating.

10. The method of claim 9, wherein the direct heating comprises injecting compressed hot air into the processing frame to heat the tube.
